(19) United States
(12) Patent Application Publication
(10) Pub. No.: US 2006/0207494 A1
(43) Pub. Date: Sep. 21, 2006

(54) Staff-mounted banner

(76) Inventors: Kenneth Steven Paley, Cincinnati, OH (US); Daniel Frederick Nesbitt, Cincinnati, OH (US)

Correspondence Address: HASSE & NESBITT LLC, 7550 CENTRAL PARK BLVD., MASON, OH, 45040, US

(21) Appl. No.: 11/384,911

(22) Filed: Mar. 20, 2006

Related U.S. Application Data
(60) Provisional application No. 60/663,779, filed on Mar. 21, 2005.

(51) Int. Cl. G09F 17/00

(52) U.S. Cl. 116/173

(57) ABSTRACT

A staff-mountable banner that can be affix to a diagonally-positioned banner staff whereby the banner hangs flat without a fold or pleat. The banner can be made of a flexible material and can have the shape of a right trapezoid. The banner has a sleeve along its angled side through which the staff extends to secure the banner to the staff.

### CROSS-REFERECNE TO RELATED APPLICAITONS

This application claims the benefit of U.S. Provisional Patent Application 60/663,779, filed Mar. 21, 2005.

### BACKGROUND

Businesses, government offices and individuals display a wide variety of flags and banners. Flags include national, state, city and local governments, organization and association flags, as well as novelty designs. Individuals and companies display the flags from flagpoles and other flag and banner supports.

Flags and banners are typically square or rectangular in shape. Some have a triangular shape, such as a pennant, while others may have a curvilinear shape with at least one side straight where the flag is attached to the flag pole or staff. There are various ways of arranging the flag staff when a flag or banner is displayed. One traditional way is to orient the staff vertically (normal to the ground). In this arrangement, a flag will typically drape and fold downward under its own weight. It is usually only possible to see the flag or banner's full display when a brisk wind is blowing, and the flag is blown straight outward, or when the staff is further equipped with a horizontally-extending support member, from which the flag or banner is supported. Another way then that a staff can be oriented is horizontally, where the flag is attached to the horizontal staff along a top edge, and the flag or banner drags downward under its own weight. This type of top-edge supported flag or banner will have a straight, horizontally-arranged top edge, with straight sides to assume a rectilinear or pennant shape, or with curvilinear sides or shape. A horizontally-supported banner can hang generally flat with few folds or draping, to provide a generally full display of the flag or banner and its design. However, only a portion of all flags and banners displayed are horizontally supported.

Another more popular way of orienting the staff, particularly for residential use, is on an angle, typically between about 30 and 45° downward from vertical. Such staffs and banners are typically mounted on the side of homes and buildings, and can use either a staff that is secured in place, or a removable staff that is inserted into a holder. The design and display of a flag or banner (the terms being used hereinafter interchangeably) that is flown from a diagonally-arranged staff is more easily seen and recognized than when the same banner is displayed from a vertical staff, although there generally remains a significant amount of draping and folding that generally obstructs its display.

Therefore, there remains a need to provide a banner, and a banner-and-staff assembly, which can hang flat, with only nominal folding or draping, and which can be displayed from a diagonally oriented pole or staff without significant draping that can obscure the view of the design of the banner.

### SUMMARY OF THE INVENTION

The present invention relates to a banner that is configured to hang flat from a diagonal staff without a fold or pleat.

The invention also relates to a banner made from a flexible material in the shape of a right trapezoid, configured for securement only along its angled side, to a staff.

The invention also relates to a banner made from a flexible material and configured to hang flat from a staff that is positioned at an acute angle θ down from vertical, the banner having at least three sides and comprising: a) a first side configured with a means for securement only along the length of the staff, where the first side has an upper end and a lower end, b) a second side extending from the upper end of the first side, and forming an angle α with the first side that is less than or equal to θ; and c) a third side extending from the lower end of the first side, and forming an angle β with the first side that is less than 180°−θ.

The invention further relates to a staff-mounted banner, comprising: 1) a staff having a first fixed end and a second distal end, positioned at an angle θ down from vertical, and 2) a banner having at least three sides, comprising: a) a first side configured for securement along the length of the staff, where the first side has an upper end and a lower end, b) a second side extending from the upper end of the first side, and forming an angle α with the first side that is less than or equal to θ; and c) a third side extending from the lower end of the first side, and forming an angle β with the first side that is less than 180°−θ.

### BRIEF DESCRIPTION OF THE FIGURES

FIG. 1 shows a front elevation an embodiment of a banner in accordance with the present invention.

FIG. 2 shows an embodiment of a banner and staff assembly in accordance with the present invention.

FIG. 3 shows another embodiment of a banner and staff assembly in accordance with the present invention.

FIG. 4 shows a further embodiment of a banner and staff assembly in accordance with the present invention.

FIG. 5 shows another embodiment of a banner and staff assembly in accordance with the present invention.

FIG. 6 shows yet another embodiment of a banner and staff assembly in accordance with the present invention.

FIG. 7 shows a left side elevation view of the banner of FIG. 1.

FIG. 8 shows a right side elevation view of the banner of FIG. 1.

FIG. 9 shows a back elevation view of the banner of FIG. 1.

### DETAILED DESCRIPTION OF THE INVENTION

The present invention relates to banners, flags, pennants and other flexible displays (hereinafter referred to as a group referred as “banner”) made from a flexible material, selected from cloth, plastics, and fabrics. A preferred fabric is woven nylon.

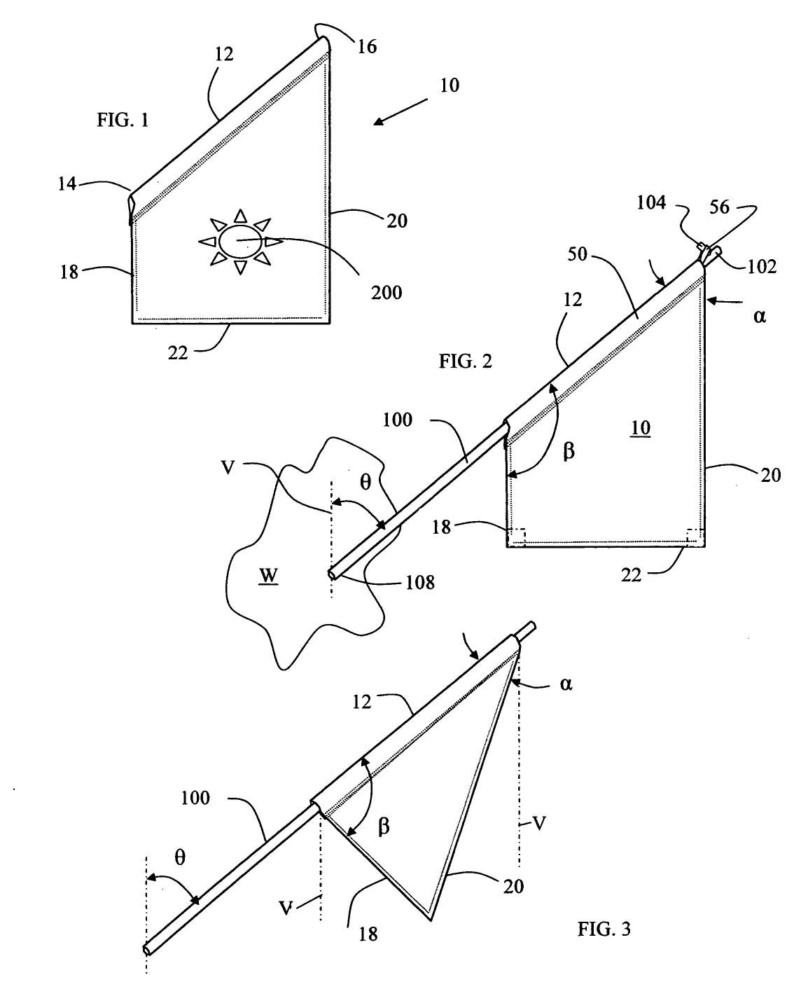

In a first embodiment, the invention provides a staff-mountable banner in the shape of a right trapezoid, shown in FIG. 1. The banner 10 has a first side 12 that forms the diagonal side of the banner, along which the banner is affixed, or secured, to a staff. The banner is typically affixed to a staff that is disposed at an angle to vertical. The banner has second side 18 and third side 20, shown extending in parallel downward from the first or lower end 14 and the second or upper end 16, respectively, of the first side 12. A fourth side 22 joins the lower ends of the two parallel sides 18 and 20 at substantially right angles, to form a right trapezoid shape. Generally, the third side 20 can be at least about 5% longer, at least about 10% longer, at least about 20% longer, at least about 50% longer, and at least about 100% longer, than the length of the second side 18. Typically the acute angle of the right trapezoid is between 30° and 80°.

The banner can have any design or pattern 200 of shapes, lines, pictures, and the like, on either or both surfaces of the banner. The banner can optional have one or more opening or cut-out penetrating through the material of the banner, either within or along the perimeter of the banner.

FIG. 2 shows the banner 10 secured to a staff 100 along the first edge 12 using a securement 50, shown as a sleeve 52 that runs the full length of the side 12, and through which the staff extends. The sleeve comprises a tubular loop of material with an axial opening there through. Alternatively a plurality of sleeves can be disposed at the ends or along the length of the side 12. A loop 56 can be formed proximate the upper end of the first side 12 of the banner, to affixed to a hook or pin 104 extending from the distal end 102 of the staff, to prevent the sleeve of the banner form sliding down the length of the staff. The banner preferably is affixed only along its first side to the staff, and is free from attachment along its remaining second, third or additional sides.

Alternative means for securing the banner staff can be used, such as grommets formed along the edge 12, typically at least at each end 14 and 16, that can secured with rope to the staff. Other securements well known to persons skilled in the art can be used.

The staff 100 used to mount the banner 10 is typically itself mounted onto a wall W or other vertical, or near vertical, surface with a holder (not shown) to which, or into which, the base end 108 of the staff can be inserted or secured. Typically the staff is an elongated cylinder. The staff 100 is typically positioned at an angle θ down from vertical of more than 0° and less than 90° degrees, more typically between 30° and 80°.

In the illustrated embodiment, an angle α is formed by the first edge 12 and the third side 20 of the banner, and an angle θ is formed by the first edge 12 and the second side 18 of the banner. The angle α is typically greater than 0° and less than 90°, and more typically between about 20° and 80°, while the angle β is typically greater than 90° and less than 180°, and more typically between about 100° and 160°. Preferably the banner 10 is a right trapezoid, and the angle θ is configured or set whereby the angle α is about equal to angle θ. This configuration provides that the second and third edges 18 and 20 depend vertically downward from the first and second ends 14 and 16 of the first edge 12, and enables the banner to hang flat, with only nominally-sized folds or draping. This configuration of banner and staff allow for maximum or optimum display of the design 200 provided on the banner.

FIG. 3 shows an alternative embodiment of a banner of the present invention, having only a first securement side 12, and second and third sides 18 and 20 that join to form the shape of a triangle. This banner is also formed with banner angles a and β. The angle α in this embodiment is typically between about 20° and 80°, while the angle β is typically between about 60° and 160°.

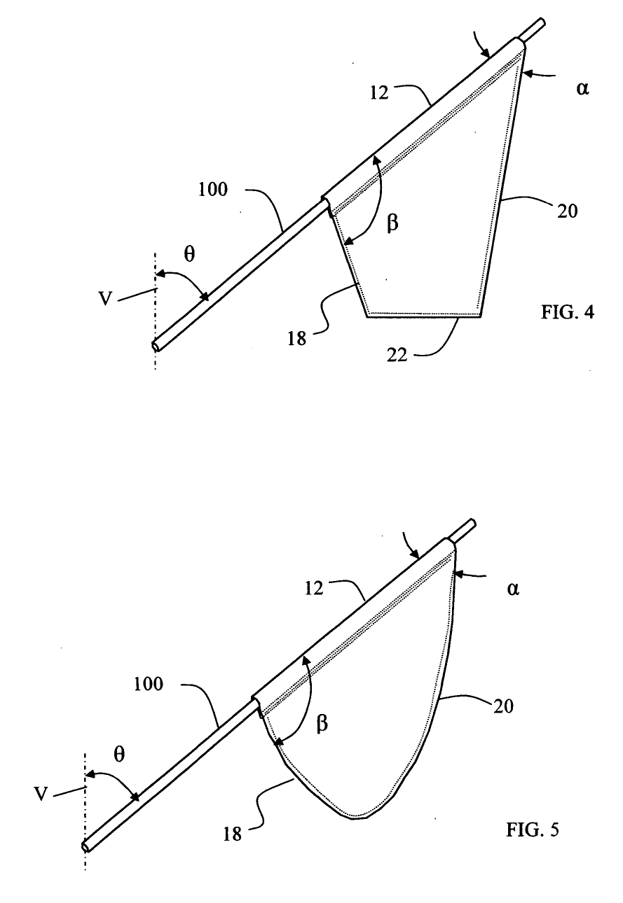

FIG. 4 shows another embodiment of a banner of the present invention, having four total sides, where either or both of the second and third sides 18 and 20 are configured at angles β and α, respectively, and both sides extend inwardly from vertical lines, shown as lines V. The fourth line 22 is shown joined to the second and third lines

FIG. 5 shows yet another embodiment of a banner of the present invention, where the second and third sides 18 and 20 are curvilinear.

In can be understood that a banner of any of the embodiments having a longer (or shorter) length and width is within the scope of the invention.

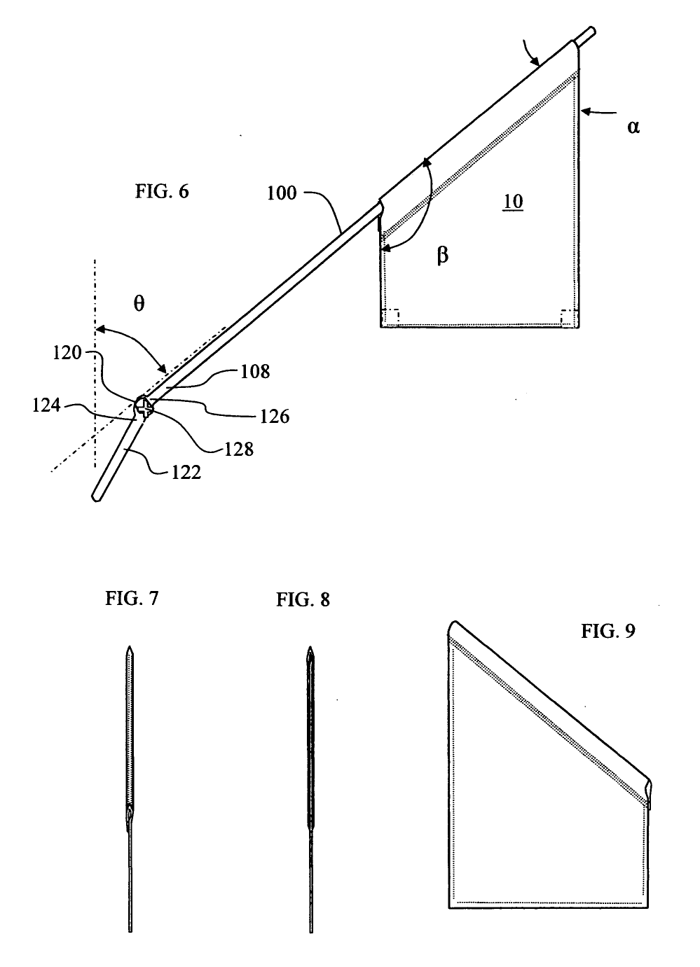

In an alternative embodiment of the invention shown in FIG. 6, the staff 100 can comprise an adjustable hinge 120 that is typically positioned proximate the base end 108, for adjusting the angle θ of the staff. A fixed member 122 is typically rigidly secured to the vertical surface W, and has a distal end 124 that forms one portion of the adjustable hinge 120, that cooperates with a second portion 126 formed at the base end of the staff. The typical, well-known adjustable hinge can comprise a pair of confronting, engageable ratchet elements, each ratchet element comprising a plurality of radially disposed ratchet teeth. A hinge adjustment means, such as a handled bolt 128 can be loosened or tightened to release or fix, respectively, the confronting ratchet elements of the hinge. The embodiment allows the staff to be set to any desired angle θ to accommodate banners of various sizes and types, as provided herein.

While specific embodiments of the apparatus of the present invention have been described, it will be apparent to those skilled in the art that various modifications thereto can be made without departing from the spirit and scope of the present invention as defined in the appended claims.

We claim:

1. A banner made from a flexible material in the shape of a right trapezoid, configured for securement only along its angled side to a staff.

2. The banner of claim 1, comprising at least one securing means positioned along the angled side and configured to attach to the staff.

3. The banner of claim 2, wherein the right trapezoid has an acute angle of between 30° and 80°.

4. The banner of claim 2 wherein the securing means comprises a sleeve.

5. The banner of claim 1 wherein the flexible material is woven nylon.

6. A banner configured to hang flat from a staff that is positioned at an acute angle θ down from vertical, the banner having at least three sides and comprising:
a) a first side configured with a means for securement only along the length of the staff, where the first side has an upper end and a lower end,
b) a second side extending from the upper end of the first side, and forming an angle α with the first side that is less than or equal to θ; and
c) a third side extending from the lower end of the first side, and forming an angle β with the first side that is less than 180°−θ.

7. The banner of claim 6, further comprising a fourth side disposed between the second side and the third side.

8. The banner of claim 7 wherein the banner has the shape of a right trapezoid.

9. The banner of claim 6, wherein the second and third sides are curvilinear.

10. The banner of claim 6, comprising at least one securing means positioned along the first side and configured to attach to the staff.

11. The banner of claim 10, wherein the securing means comprises at least one sleeve, through which the staff extends.

12. The banner of claim 10, wherein the securing means comprises at least a first and a second grommet, proximate to the first and second ends, respectively.

13. A staff-mounted banner, comprising:
a) a staff having a first fixed end and a second distal end, positioned at an acute angle θ down from vertical, and
b) a banner having at least three sides, comprising:
1) a first side comprising at least one securing means positioned only along the first side and configured for securement along the length of the staff, where the first side has an upper end and a lower end,
2) a second side extending from the lower end of the first side, and forming an angle β with the first side that is less than 180°−θ; and
3) a third side extending from the upper end of the first side, and forming an angle α with the first side that is less than or equal to θ.

14. The staff-mounted banner of claim 13, further comprising a fourth side disposed between the second side and the third side.

15. The staff-mounted banner of claim 14 wherein the banner has the shape of a right trapezoid.

16. The staff-mounted banner of claim 13, wherein the securing means comprises a sleeve, through which the staff extends.

17. The staff-mounted banner of claim 13, wherein the staff comprises an adjustable hinge proximate the fixed end, for adjusting the angle θ of the staff.
